(19) United States
(12) Patent Application Publication
(10) Pub. No.: US 2019/0335218 A1
(43) Pub. Date: Oct. 31, 2019

(54) Method of real-time file format conversion streaming service

(71) Applicant: PANDORATV CO., LTD, Gyeonggi-do (KR)

(72) Inventors: Yeung Do NAM, Gyeonggi-do (KR); Min Seok PARK, Gyeonggi-do (KR); Jae Chun KIM, Gyeonggi-do (KR); Kyoung Wook KIM, Seoul (KR)

(21) Appl. No.: 16/462,158

(22) PCT Filed: Oct. 19, 2017
(86) PCT No.: PCT/KR2017/011602

§ 371 Date: May 17, 2019

(30) Foreign Application Priority Data
Nov. 17, 2016 (KR) 10-2016-0153066

(51) Int. Cl. H04N 21/2662; H04N 21/2343; H04N 21/24

(52) U.S. Cl. CPC H04N 21/2662; H04N 21/2408; H04N 21/234309

(57) ABSTRACT

Method of real-time file format conversion streaming disclosed. The method includes receiving a request for video content from a user terminal, selecting a service format based on a device check on the user terminal, if a file format of requested video content is MP4, based on the service format, maintaining the file format of service content to be provided, or converting the file format to FLV or HLS file format by analyzing a header data, and streaming the service content to the user terminal.

### FIELD OF INVENTION

The present invention relates to method of real-time file format conversion streaming service for providing video content effectively.

### RELATED ART

As the Internet and communication devices such as computer, smart phone, tablet has been developed, a user can access easily to video content such as music video, UCC, movies at any time and at any location.

It was common that video content was downloaded to device and then played, but now days, video streaming is mainly used due to high speed communication. Most of video content available on the web uses MP4 file format. In case that video content in MP4 file format is provided in streaming, a header data should be provided prior to any remaining video data. As the size of video content increases, the size of header data also increases. Playing video content is delayed until download of header data completed. This makes the user inconvenient. In particular, when the user skips some portion of video content while watching, the user feels more inconvenient because MP4 header data should be downloaded again and this takes time.

### SUMMARY

Accordingly, the present invention is made to overcome aforementioned problems, its objective is to provide a method and a computer-readable medium for executing the method of providing real-time file conversion streaming service that converts MP4 file format of video content to FLV, HLS based on a situation of user terminal.

Other objectives will be more clarified through embodiment to be described more detail below.

According to one aspect of the present invention, there are provided a method and a computer-readable medium for executing the method of providing real-time file conversion streaming service performed by a server that provides video streaming service. The method includes receiving a request for video content from a user terminal, selecting a service format based on a device check on the user terminal, if a file format of requested video content is MP4, based on the service format, maintaining the file format of service content to be provided, or converting the file format to FLV or HLS file format by analyzing a header data, and streaming the service content to the user terminal.

The converting the file format may include analyzing a communication environment with the user terminal. A decision of file format conversion is made based on the communication environment.

The converting the file format may include checking a rate of skip occurrence based on a usage history of the service content. The file format conversion is performed only when the rate of skip occurrence is equal to or greater than a predetermined threshold value.

The threshold value is differently decided based on a total play time of the service content.

The converting the file format may include checking a rate of skip occurrence based on a usage history of user. The file format conversion is performed only when the rate of skip occurrence is equal to or greater than a predetermined threshold value.

According to another aspect of the present invention, there are provided a method and a computer-readable medium for executing the method of providing real-time file conversion streaming service performed by a server that provides video streaming service. The method includes receiving a request for video content from a user terminal, streaming the video content to the user terminal, receiving a skip request for the video content from the user terminal, if a file format of the video content is MP4, converting the file format to FLV or HLS file format by analyzing a header data based on a service format corresponding to a device of the user terminal, and streaming the video content in a converted file format to the user terminal.

The file format may be converted to the service format only when receiving the skip request more than a predetermined times

According to the present invention, by dynamically converting video content in MP4 file format to FLV or HLS based on the situation of user terminal, a delay time due to the transmission of MP4 header data can be reduced.

In addition, according to the present invention, by converting file format and streaming in real-time, there is no need to store all file formats of video content so it becomes possible to utilize storage space for content more effectively.

### BRIEF DESCRIPTION OF THE DRAWINGS

FIG. 1 is a block diagram showing a server that provides real-time file format conversion streaming service according to one embodiment of the present invention;

FIG. 2 is a flowchart showing a process of real-time file format conversion stream service according to one embodiment of the present invention;

FIG. 3 illustrates a format conversion of MP4 file according to one embodiment of the present invention.

FIG. 4 and FIG. 5 are flowcharts showing a process of file format conversion according to one embodiment of the present invention.

FIG. 6 is a flowchart showing a process of real-time file format conversion streaming service according to another embodiment of the present invention.

### DESCRIPTION OF EXEMPLARY EMBODIMENTS OF THE INVENTION

The invention can be modified in various forms and specific embodiments will be described and shown below. However, the embodiments are not intended to limit the invention, but it should be understood that the invention includes all the modifications, equivalents, and replacements belonging to the concept and the technical scope of the invention.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Elements of an embodiment described below with reference to the accompanying drawings are not limited to the corresponding embodiment, may be included in another embodiment without departing from the technical spirit of the invention. Although particular description is not made, plural embodiments may be embodied as one embodiment.

In describing the invention with reference to the accompanying drawings, like elements are referenced by like reference numerals or signs regardless of the drawing numbers and description thereof is not repeated. If it is determined that detailed description of known techniques involved in the invention makes the gist of the invention obscure, the detailed description thereof will not be made.

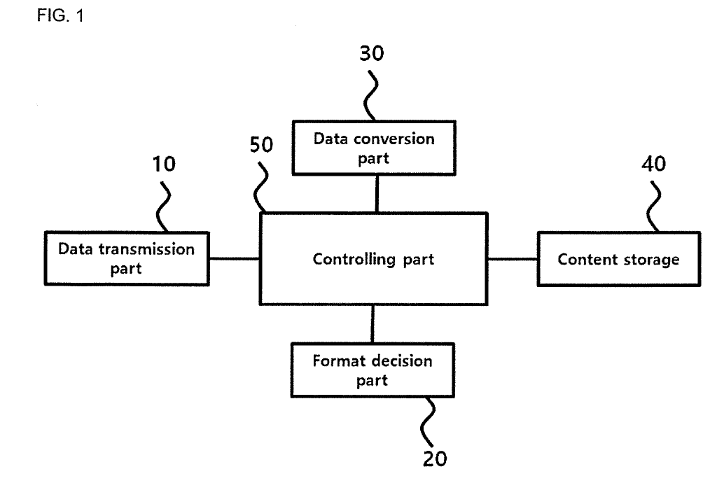

FIG. 1 is a block diagram showing a server that provides real-time file format conversion streaming service according to one embodiment of the present invention.

Referring to FIG. 1, the server may include a data transmission part 10, a format decision part 20, a data conversion part 30, a content storage 40, and a controlling part 50.

Data transmission part 10 is configured for providing a streaming service to a user terminal, and more particularly, providing a service content by using each protocol according to file format of content to be provided (hereinafter, referred as service content).

Content storage 40 stores video content to be provided to the user terminal. In this embodiment, it will be assumed that the content storage 40 mainly stores video content in MP4 format. Of course, content in FLV or HLS file format will be also stored.

Format decision part 20 decides the file format of service content to be provided to the user terminal (hereinafter, referred as service format). In one example, the format decision part 20 may check a device of the user terminal and then decide the service format proper to the device. As example, the format decision part 20 may decide FLV as service format if the user terminal is a PC (Personal computer); HLS as service format if the user terminal is IPhone using IOS; or MP4 as service format if the user terminal is using Android OS. These are only a portion of examples, so it should not be limited these file formats. In another example, the service format may be decided according to a type of CODEC being installed in the user terminal.

Data conversion part 30 converts the file format of the service content to the service format decided by the format decision part 20.

Controlling part 50 controls each component. For example, controlling part 50 may control the way of how the format decision part 20 will decide the service format, or whether or when the data conversion part 30 will perform a file conversion.

Hereinafter, the method of providing stream service in the abovementioned server will be described with reference to embodiments according to each process.

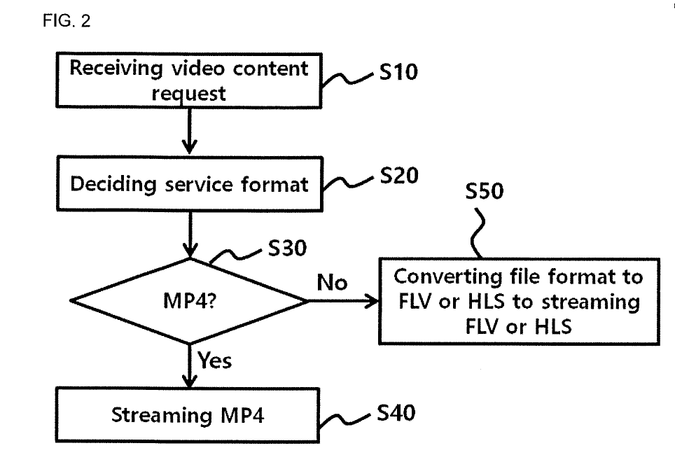

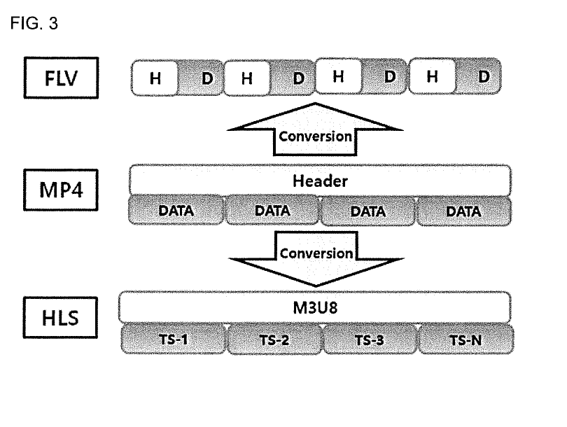

FIG. 2 is a flowchart showing a process of real-time file format conversion stream service according to one embodiment of the present invention, and FIG. 3 illustrates a format conversion of MP4 file according to one embodiment of the present invention.

Referring to FIG. 2, when receiving a video content request from a user terminal (310), server decides a service format of video content to be provided (S20). In one example of deciding service format, as described above, device of user terminal (terminal itself or OS) may be checked and then a service format decided for the device in advance may be selected. Information about the device may be received from the user terminal. For example, a request URL (for example, http://mcs.com/a.mp4?format=MP4) may include information of requesting MP4.

Once the service format is decided, server checks whether the service format is MP4 (S30), and if MP4, then provides stream service in MP4 format (S40). In MP4, a file container may be MP4, CODEC may be H.264/MPEG4SP, and a transmission protocol may be HTTP.

On the contrary, if the service format is FLV or HLS, server converts the file format of the service content and provides stream service (S50).

For example, in case of FLV, the service content in MP4 format may be converted to FLV, transmitted in FLV container by using RTMP protocol, and CODEC may be VP6. In case of HLS, the server may transmit the service content in TS container by using HLS protocol and the user terminal may play the service content by using H.264 (MPEG-4 Part 10 AVC).

Referring together with FIG. 3, in case of service content in MP4 format, all of header data should be received in order to play the service content, but, in case of video content in FLV format, header data and video data is divided into several segments so it is possible to instantly play when receiving one or more segments.

As describing a process of handing HLS file format in detail, server may analyze MP4 file to generate HLS meta file (m3u8) in real-time and to transmit to the user terminal, And, when receiving MPEG2-TS file included in the meta file from the user terminal, server may convert the MP4 file to MPEG2-TS file in real-time and be streaming.

Thus, as compared to MP4 file in which all header data should be transmitted again when a play skip occurs, it is possible to reduce waiting time in FLV or HLS file format since it is enough to transmit only a portion of header data or video data so a user can watch the service content without any delays.

According to one embodiment, server may provide streaming service in each file format even if all video content stored in the content storage is in MP4 file format. This may allow to utilize a storage space in more efficient way compared to a conventional way of storing video content in various file formats. In other words, if server stores same video content in each file format, it is disadvantageous because cost for maintaining each storage will increase, but the embodiment according to the present invention can solve this problem.

In addition, the aforementioned embodiment relates to a method of providing stream service by converting a file format to a predetermined service format. In another embodiment, a file conversion may be performed only when a certain condition(s) is satisfied. This embodiment will be described below.

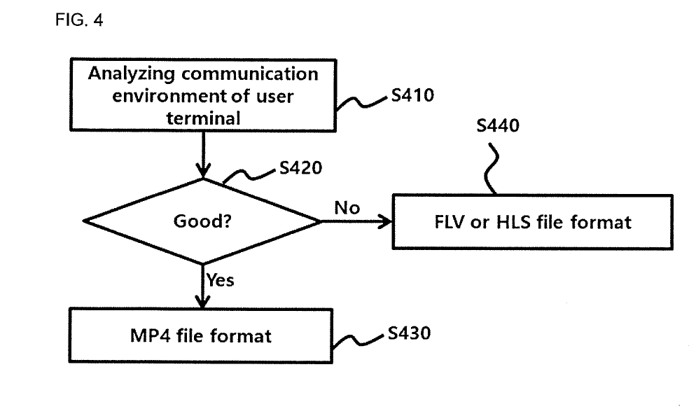

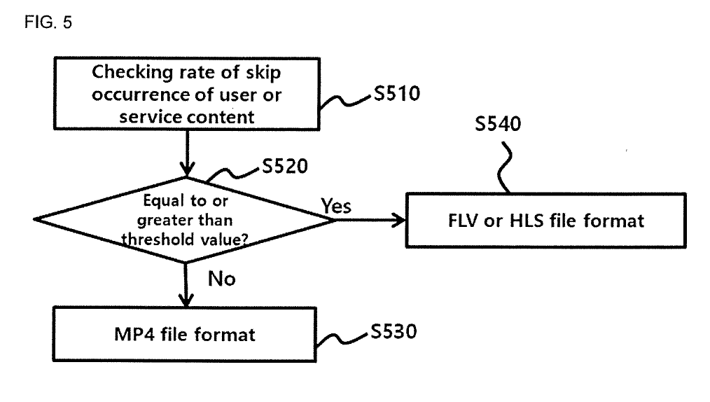

FIG. 4 and FIG. 5 are flowcharts showing a process of file format conversion according to each embodiment of the present invention.

Referring to FIG. 4 of one embodiment, server analyzes communication environment in which the user terminal is located (S410), and decides a quality of the communication environment (S420). For example, the quality of communication environment can be decided by a time duration to be took for the user terminal to receive all of header data of service content in MP4 file format. If the time duration from a start time of transmitting header data to an end time of receiving a response signal indicating that the user terminal receives all header data is equal to or less than 0.3 seconds, the quality of communication environment can be decided as good.

Once the quality of communication environment is decided as good, the service format may be decided to be MP4 as original file format (S430). On the contrary, if the quality of communication environment is decided as not good, the service format may be decided as one among FLV and HLS, according to the user terminal (S440).

In one embodiment, by transmitting the service content in original MP4 file format to the user terminal with high data communication rate and by transmitting the service content in the converted file format to the user terminal with low data communication rate, it becomes possible for the user to watch the service content seamlessly even if skip occurs. In addition, the number of times to convert file format can be reduced so the burden of server to convert file format can be also reduced.

Referring to FIG. 5 according to another embodiment, server checks a rate of skip occurrence according to a usage history of the user or service content (S510). In detail, by checking the usage history (for example, the number of times that the user has requested video content streaming service, the average number of skips per service content, and so on) of the user who requests the stream service, server may decide the rate of skip occurrence, which is how many times the user skips during watching video content. Also, by checking the usage history for the requested service content (the number of views, a rate of users who skipped the service content, an average number of skips, and so on), server may decide the rate of skip occurrence.

Server decides whether the rate of skip occurrence is equal to or greater than a threshold value (S520), and if equal to or greater than the threshold value, server decides to perform the file format conversion (S540), Namely, since high rate of skip occurrence indicates high possibility that skip will occur, server may convert the file format of service content to FLV or HLS, which is suitable for being skipped, to provide stream service.

Here, the threshold value may be changed dynamically. For example, in case of using the rate of skip occurrence of the service content, the threshold value may be set differently according to total play time of the service content. For example, if the play time of service content is equal to or less than one minute, the threshold value may be set to 30%; or if the play time of service content is greater than one minute, the threshold value may be set to 20%.

Referring again to FIG. 5, if the rate of skip occurrence is less than threshold value, server streams the service content in MP4 file format that is original file format (S530).

According to the present embodiment, since unnecessary file conversion will not be performed, the burden of server to convert file format can be reduced.

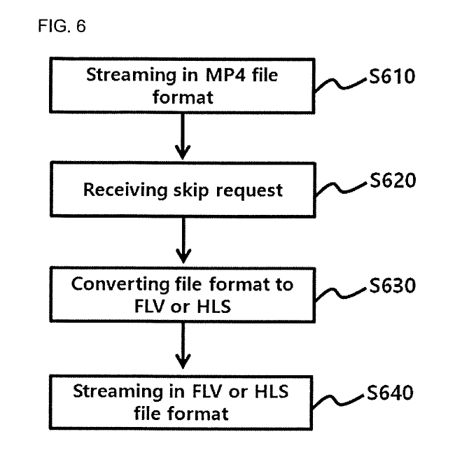

FIG. 6 is a flowchart showing a process of real-time file format conversion streaming service according to another embodiment of the present invention.

Referring to FIG. 6, server provides streaming service for service content in MP4 file format as is (S610).

If receiving a skip request for the service content from the user terminal (S620), instead transmitting header data for MP4 file format, server converts the file format of service content to FLV or HLS, which is suitable for the user terminal (S630), and transmits streaming in a protocol proper to that file format (S640).

Here, it is possible that the file format can be converted when receiving the first skip request, but in other example, the file format of service content can be converted when the number of skip requests are received greater than predetermined times (for example, two times). In addition, the file format can be converted when the skip requests are received several times within a certain time duration (for example, 20 seconds).

The real-time file format conversion streaming method according to the invention can be embodied as codes which can be read by a computer on a computer-readable recording medium. Examples of the computer-readable recording medium include all the types of recording mediums on which data readable by a computer system is stored. Examples thereof include a read only memory (ROM), a random access memory (RAM), a magnetic tape, a magnetic disc, a flash memory, and an optical data storage device. The computer-readable recording medium can be distributed in computer systems connected from one another via a computer communication network and can be stored and executed as codes which can be read in a distribution manner.

While exemplary embodiments of the invention have been described above, it will be understood by those skilled in the art that the invention can be modified in various forms without departing from the spirit and scope of the invention described in the appended claims.

1. A method of providing real-time file conversion streaming service performed by a server that provides video streaming service, comprising:
receiving a request for video content from a user terminal;
selecting a service format based on a device check on the user terminal;
if a file format of requested video content is MP4, based on the service format, maintaining the file format of service content to be provided, or converting the file format to FLV or HLS file format by analyzing a header data; and
streaming the service content to the user terminal,
wherein once the file format is decided to be converted, checking a rate of skip occurrence based on a usage history of a user and a usage history of the service content, and performing a file format conversion only when the rate of skip occurrence is equal to or greater than a threshold value that is decided based on a total play time of the service content,
wherein once the file format is decided to be maintained, performing the file format conversion when receiving a skip request from the user terminal during streaming the service content.

2. The method according to claim 1, wherein the converting the file foil rat comprises analyzing a communication environment with the user terminal,
wherein a decision of file format conversion is made based on the communication environment.

3. The method according to claim 1,
wherein the file format conversion is performed only when the number of times of receiving the skip request is equal to or greater than a predetermined number of times.

4-7. (canceled)

8. A computer-readable medium comprising a program for executing method of claim 1.
